(19) United States
(12) Patent Application Publication
(10) Pub. No.: US 2005/0210429 A1
(43) Pub. Date: Sep. 22, 2005

(54) System and method to limit runtime of VLSI circuit analysis tools for complex electronic circuits

(76) Inventors: S. Brandon Keller, Evans, CO (US); Gregory Dennis Rogers, Ft. Collins, CO (US); George Harold Robbert, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/803,714

(22) Filed: Mar. 18, 2004

(51) Int. Cl. G06F 17/50

(52) U.S. Cl. 716/4

(57) ABSTRACT

A method of using a software tool to analyze a VLSI circuit is described. In one embodiment, the method comprises, prior to initiating analysis of the circuit, performing a complexity check on the circuit; responsive to the circuit failing the complexity check, aborting analysis of the circuit; and responsive to the circuit passing the complexity check, initiating analysis of the circuit and continuing analysis of the circuit until expiration of a predetermined time period following the initiating.

### CROSS-REFERENCE TO RELATED APPLICATIONS

This application is related to the following commonly-owned, co-pending U.S. patent applications: U.S. patent application No.______, filed______ entitled “SYSTEM AND METHOD TO OPTIMIZE LOGICAL CONFIGURATION RELATIONSHIPS IN VLSI CIRCUIT ANALYSIS TOOLS” (Docket No. 200311735-1); U.S. patent application No.______, filed ______entitled “SYSTEM AND METHOD FOR FACILITATING EFFICIENT APPLICATION OF LOGICAL CONFIGURATION INFORMATION IN VLSI CIRCUIT ANALYSIS TOOLS” (Docket No. 200311736-1); U.S. patent application No.______, filed______ entitled “SYSTEM AND METHOD TO PRIORITIZE AND SELECTIVELY APPLY CONFIGURATION INFORMATION FOR VLSI CIRCUIT ANALYSIS TOOLS” (Docket No. 200311762-1); U.S. patent application No.______, filed______entitled “SYSTEM AND METHOD FOR FLATTENING HIERARCHICAL DESIGNS IN VLSI CIRCUIT ANALYSIS TOOLS” (Docket No. 200311777-1); and U.S. patent application No.______, filed______entitled “SYSTEM AND METHOD FOR CONTROLLING ANALYSIS OF MULTIPLE INSTANTIATIONS OF CIRCUITS IN HIERARCHICAL VLSI CIRCUIT DESIGNS” (Docket No. 200311778-1); all of which are hereby incorporated by reference in their entirety.

### BACKGROUND

In the field of integrated circuit (“IC”) design and particularly very large scale integration (“VLSI”) design, it is desirable to test the design before implementation and to identify potential violations in the design. Before implementation on a chip, the information about a design, including information about specific signals and devices that comprise the design, as well as information about connections between the devices, are typically stored in a computer memory. Based on the connection and device information, the designer can perform tests on the design to identify potential problems. For example, one portion of the design that might be tested is the conducting material on the chip. In particular, representations of individual metal segments may be analyzed to determine whether they meet certain specifications, such as electromigration and self-heating specifications. Other tests that may be conducted include electrical rules checking tests, such as tests for noise immunity and maximum driven capacitance, and power analysis tests that estimate power driven by a particular signal and identify those over a given current draw. These tests may be performed using software tools referred to as VLSI circuit analysis tools.

Modern semiconductor IC chips include a dense array of narrow, thin-film metallic conductors, referred to as “interconnects”, that transport current between various devices on the IC chip. As the complexity of ICs continues to increase, the individual components must become increasingly reliable if the reliability of the overall IC is to be maintained. Due to continuing miniaturization of VLSI circuits, thin-film metallic conductors are subject to increasingly high current densities. Under such conditions, electromigration can lead to the electrical failure of interconnects in a relatively short period of time, thus reducing the lifetime of the IC to an unacceptable level. It is therefore of great technological importance to understand and control electromigration failure in thin film interconnects.

Electromigration can be defined as migration of atoms in a metal interconnect line due to momentum transfer from conduction electrons. The metal atoms migrate in the direction of current flow and can lead to failure of the metal line. Electromigration is dependent on the type of metal used and correlates to the melting temperature of the metal. In general, a higher melting temperature corresponds to higher electromigration resistance. Electromigration can occur due to diffusion in the bulk of the material, at the grain boundaries, or on the surface. For example, electromigration in aluminum occurs primarily at the grain boundary due to the higher grain boundary diffusivity over the bulk diffusivity and the excellent surface passivation effect of aluminum oxide that forms on the surface of aluminum when it is exposed to oxygen. In contrast, copper exhibits little electromigration in the bulk and at the grain boundary and instead primarily exhibits electromigration on the surface due to poor copper oxide passivation properties.

Electromigration can cause various types of failures in narrow interconnects, including void failures along the length of a line and diffusive displacements at the terminals of a line that destroy electrical contact. Both types of failure are affected by the microstructure of the line and can therefore be delayed or overcome by metallurgical changes that alter the microstructure. As previously noted, electromigration is the result of the transfer of momentum from electrons moving in an applied electric field to the ions comprising the lattice of the interconnect material. Specifically, when electrons are conducted through a metal, they interact with imperfections in the lattice and scatter. Thermal energy produces scattering by causing atoms to vibrate; the higher the temperature, the more out of place the atom is, the greater the scattering, and the greater the resistivity. Electromigration does not occur in semiconductors, but may in some semiconductor materials that are so heavily doped as to exhibit metallic conduction.

The driving forces behind electromigration are “direct force”, which is defined as the direct action of the external field on the charge of the migrating ion, and “wind force”, which is defined as the scattering of the conduction electrons by the metal atom under consideration. For simplicity, “electron wind force” often refers to the net effect of these two electrical forces. This simplification will also be used throughout the following discussion. These forces and the relation therebetween are illustrated in FIG. 1.

The electromigration failure process is predominantly influenced by the metallurgical-statistical properties of the interconnect, the thermal accelerating process, and the healing effects. The metallurgical-statistical properties of a conductor film refer to the microstructure parameters of the conductor material, including grain size distribution, the distribution of grain boundary misorientation angles, and the inclinations of grain boundaries with respect to electron flow. The variation of these microstructural parameters over a film causes a non-uniform distribution of atomic flow rate. Non-zero atomic flux divergence exists at the places where the number of atoms flowing into the area is not equal to the number of atoms flowing out of that area per unit time such that there exists either a mass depletion (divergence>0) or accumulation (divergence<0), leading to formation of voids and hillocks, respectively. In such situations, failure results either from voids growing over the entire line width, causing line breakage, or from extrusions that cause short circuits to neighboring lines.

The thermal accelerating process is the acceleration process of electromigration damage due to a local increase in temperature. A uniform temperature distribution along an interconnect is possible only absent electromigration damage. Once a void is initiated, it causes the current density to increase in the area around the void due to the reduction in the cross-sectional area of the conductor. The increase of the local current density is referred as “current crowding.” Since joule heating, or “self-heating”, is proportional to the square of current density, the current crowding effect leads to a local temperature rise around the void that in turn further accelerates the void growth. The whole process continues until the void is large enough to result in a line break.

Healing effects are the result of atomic flow in the direction opposite to the electron wind force, i.e., the “back-flow,” during or after electromigration. The back-flow of mass is initiated once a redistribution of mass has begun to form. Healing effects tend to reduce the failure rate during electromigration and partially heals the damage after current is removed. Nonhomogenities, such as temperature and/or concentration gradients, resulting from electromigration damage are the cause of the back-flow.

The effects of electromigration may be slow to develop; however, if an electromigration problem exists, the progress toward a fault is inexorable. The results of an electromigration problem are illustrated in FIGS. 2 and 3. Before current is applied to a section of an IC chip that is first powered up, the metal comprising the interconnects thereof is uniformly distributed, as illustrated in FIG. 2, which illustrates a side view of an interconnect 200. However, in a section of metal that is at risk for electromigration, the mass transport of metal, which occurs in the direction of average current, represented in FIG. 3 by an arrow 301, results in metal moving from a first end 302a of the section to a second end 302b thereof. At some future time, depending on the amount of current flowing through and the thickness of the interconnect 200, electromigration will result in the formation of a void 304 at the first end 302a and a hillock 304 at the second end 302b. Eventually, as previously described, this migration of metal from one end of the wire to the other will result in a failure of the interconnect 200.

As also previously noted, self-heating contributes to the electromigration and actually affects the surrounding wires as well. As a wire carries current, it will heat up, thereby lowering the limits for electromigration in surrounding wires as well as the wire under consideration. It is important, therefore, to consider the effects of both electromigration and self-heating (collectively “EM/SH”) when analyzing and verifying the reliability of an IC chip design.

Typically, circuit analysis tools (including, e.g., the EM/SH analysis tools) are allowed to run “as long as it takes” to achieve complete analysis of an IC design. However, as VLSI circuit designs become increasingly complex, the runtime of analysis tools that verify the IC design increases as well. In some instances, the runtime may become unacceptably long.

### SUMMARY

One embodiment is a method of using a software tool to analyze a VLSI circuit. The method comprises, prior to initiating analysis of the circuit, performing a-complexity check on the circuit; responsive to the circuit failing the complexity check, aborting analysis of the circuit; and responsive to the circuit passing the complexity check, initiating analysis of the circuit and continuing analysis of the circuit until expiration of a predetermined time period following the initiating.

### BRIEF DESCRIPTION OF THE DRAWINGS

FIG. 1 illustrates the driving forces behind electromigration, including direct force and wind force;

FIGS. 2 and 3 illustrate the effects of electromigration on an IC chip interconnect;

FIG. 4 is a flow diagram of a reliability verification tool (“RVT”) in one embodiment;

FIG. 5 is a block diagram of one embodiment of a VLSI circuit analysis tool; and

FIG. 6 is a flowchart of the operation of one embodiment of the VLSI circuit analysis tool of FIG. 5.

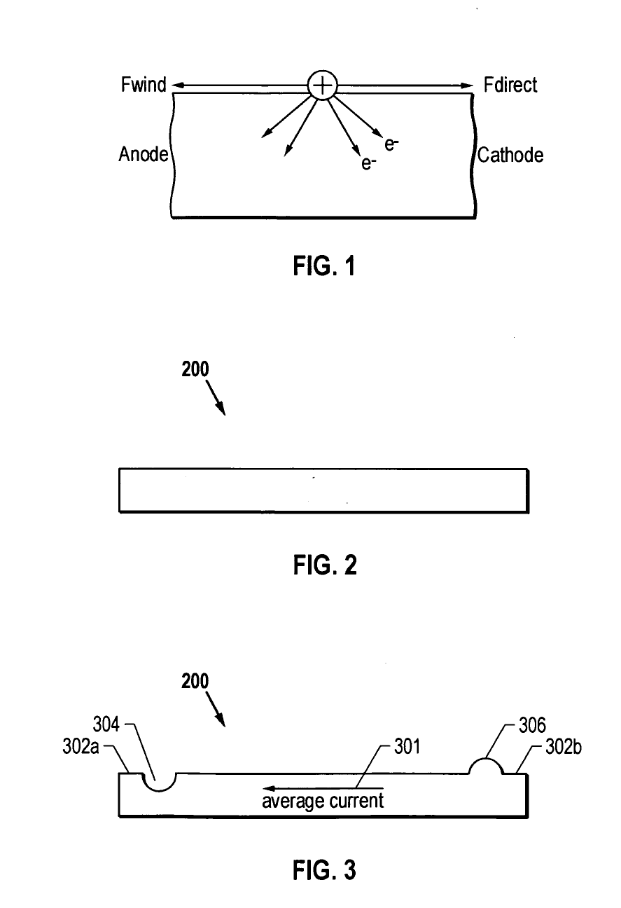

### DETAILED DESCRIPTION OF THE DRAWINGS

In the drawings, like or similar elements are designated with identical reference numerals throughout the several views thereof, and the various elements depicted are not necessarily drawn to scale.

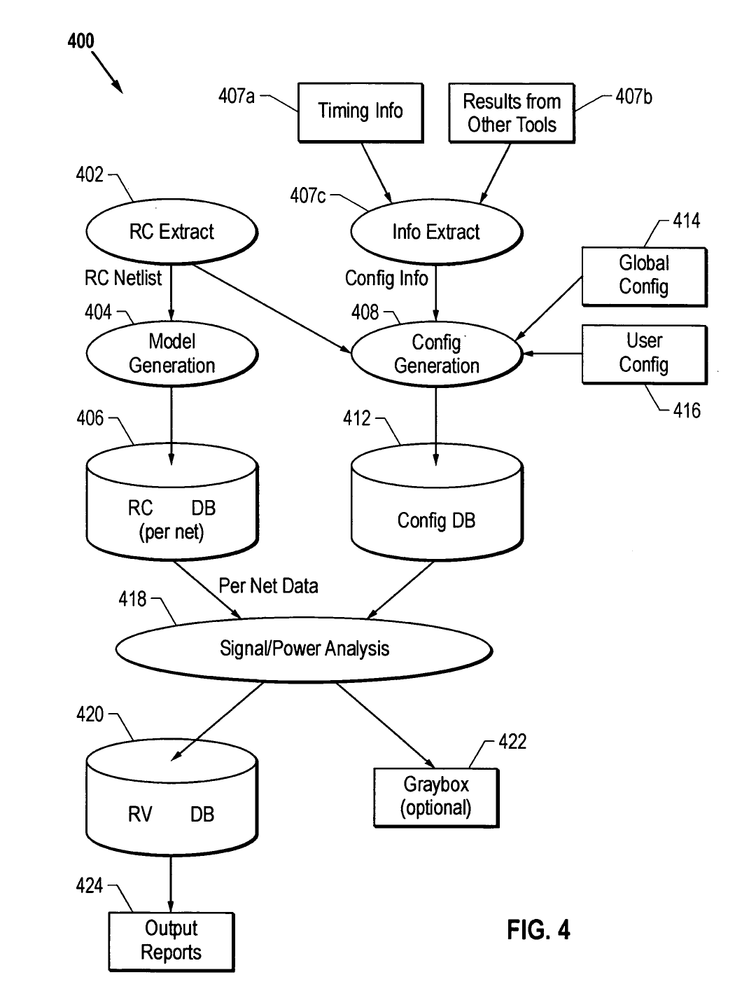

FIG. 4 is a flow diagram of one embodiment of a VLSI circuit analysis tool, specifically, a reliability verification tool (“RVT”) 400. In the illustrated embodiment, the RVT 400 is designed to find areas of an IC block layout that may have electromigration and/or self-heating (“EM/SH”) risks. The output files produced by the RVT 400 are useful for viewing violations in a text manner and a violations shapes representation can be loaded on top of the block artwork to provide a visual representation of the problem areas and the changes proposed by the RVT 400 to correct those problems.

Specifically, the RVT 400 is designed to assist designers with the challenging task of identifying potential EM/SH problem areas in their designs. Since the rules of electromigration are not always intuitive and problem areas can be hard to spot, the RVT 400 is an important tool for determining if the design has any violations that, if not discovered and corrected, could lead to future chip failure. This is due to the fact that faults that electromigration can produce develop slowly over time until the metal finally breaks.

In one embodiment, the RVT 400 provides a designer with a clear, easy-to-follow approach to identifying EM/SH violations. Theoretically, design rules should prevent most wires from risk of electromigration, but cases still exist in which there may be a problem. By running the RVT 400 on a design block, a designer can ensure that the wires in the block will be reliable in the long term and will not cause a chip failure. The RVT 400 accomplishes this by calculating the currents through each piece of metal and each contact array on the chip. It compares these currents with certain process rules describing the maximum current that a given width of metal or set of contacts may carry. Any currents that do not meet the limits are reported as violations.

In order to “calculate the currents”, as indicated above, the RVT 400 may be run in either “signal” or “power” mode to analyze metal connecting signals or to analyze the power grid. These two runs are performed separately to give better capacity and performance. In signal analysis, the RVT 400 first separates the chip into individual stages. A stage is a set of resistors that connect one or more driver FETs (i.e., those FETs that are connected to a supply) to the gates of one or more receiver FETs. These connections may pass through the channels of any number of pass FETs in the process. The RVT 400 takes each of these stages and attempts to simulate the likely combinations of on and off FETs, as dictated by logic configuration, taking the worst case currents determined over all of the simulations. The currents are then checked against the EM/SH rules.

In power analysis, the RVT 400 treats each power grid rail as its own stage. It uses the current through FETs connected to the rail determined in a previous signal analysis run to load the power grid. After simulating the grid with the load currents, it checks the currents calculated through each resistor against the EM/SH rules.

FIG. 4 illustrates the overall flow of data and control through the RVT 400. The diagram illustrated in FIG. 4 illustrates the flow that applies to both signal and power analysis. The RVT 400 relies on a special RC extract 402 to perform its analysis. In one embodiment, the RC extract 402 provides highly detailed resistance values to enable the EM/SH rules to be applied correctly.

A Model Generation module 404 processes the extracted RC information from the RC extract 402 into an RC database (“DB”) 406 for each block. This allows easy access of the information on a per-net basis so that only the nets for a particular stage, as opposed to the entire model, need to be loaded into memory. The RC DB 406 is reused from run to run of the RVT 400 and is only regenerated when a new extract is performed.

The RVT 400 also relies on configuration information, such as timing information 407a and results from other analysis tools 407b, extracted from other sources by an info extract module 407c. These sources produce configuration files that, once extracted, are read in by a configuration generation phase 408 of the RVT 400. As previously noted, the extracted configuration information input to the configuration generation phase 408 may include information extracted from circuit annotation, timing information and additional circuit properties from transistor-level static timing analysis tool runs, information extracted from circuit recognition, and node activity factor (“AF”) information.

In one embodiment, as indicated above, the RVT 400 has the ability to read some configuration information pertaining to logical relationships within the design, such as those logic configuration commands listed below. These commands may be specified via configuration files or via annotations directly associated with schematic representations of the design. Each of the block properties' values is a list of signal names, each of which may be prefixed by “!”, indicating the opposite logic sense should be applied to that signal. The block properties include:
set_high instructs the analysis tool to set the specified net(s) to logic 1
set_low instructs the analysis tool to set the specified net(s) to logic 0
unset instructs the analysis tool to that any previous set_high or set_low information should be removed from the specified net(s)
merge_nodes instructs the analysis tool to treat all of the specified nets as having the same logical value
mutex instructs the analysis tool that exactly one of the specified nets should have a value of 1
imutex instructs the analysis tool that no more than one of the specified nets should have a value of 1
ifthen instructs the analysis tool as to the logical relationship of nets based on the state of the first net
forbid forbids the specified combination of nets

In one embodiment, as also indicated above, the RVT 400 has two methods for determining the activity factor on nodes. Both of these may be overridden by user configuration information if desired. The first such method is to use the default activity factors according to the node's type as determined by circuit recognition and a transistor-level static timing analysis tool. The second is to read explicit activity factors for each node. This can either specify a user-created file for activity factors or it may run some other tool to generate activity factors. If this method is selected, any node that does not have an activity factor explicitly specified therefore will default to one based on node type.

Similar to the Model Generation module 404, the Configuration Generation module 408 consolidates all of the configuration information at the beginning of a run and places this in a Config DB 412 for easy per-net access. The Configuration Generation module 408 reads a global configuration file 414 specified by a tool administrator and a user configuration file 416 specified by a user on a per-block basis. Both of these configuration files 414, 416, may be used to override the extracted configuration if necessary.

In addition to combining all of the configuration information together in a per-net fashion, the Configuration Generation module 408 also propagates some logic configuration through a process referred to as “transitive closure”, as described in related U.S. patent application No.______ (Docket No. 200311735-1), which has been incorporated by reference in its entirety.

A signal/power analysis module 418 performs the main work of the RVT 400. It handles one stage at a time, calculating the currents through each resistor and applying the EM/SH rules. It generates both a Reliability Verification database (“RV DB”) 420, which contains all of the information it calculates, and an optional “graybox” description 422 for the file. The RV DB 420 is subsequently processed to generate the various output reports that users actually read. In order to improve performance, the analysis may be run on serval machines in parallel. As each stage is independent, requiring only the information on the nets it contains, the analysis is easily parallelizable.

It should be noted that when the RVT 400 generates a graybox 422 for a given block, it will create both a netlist, or “BDL”, file and also a config file containing all configuration information for the ports of the graybox. This allows various configuration (such as node types or activity factors) to be propagated up from a graybox. The graybox information is read in by the Model Generation module 404 and the Configuration Generation module 410 when the graybox 422 is used in the analysis of a parent block.

The RVT 400 generates a variety of output reports 424 such as a text file containing a list of all resistors that failed the EM/SH rules, along with any stages that were discarded. The RVT 400 also generates layout shapes that highlight the violations at each level of the hierarchy. The violations shapes are all stored as blocks along with the rest of the output files 424.

Running a power analysis using the RVT 400 relies on the user to have previously run a signal analysis with the RVT at or above the level on which a power analysis is to be run. During the RVT signal analysis, the default is to write out the average case and worst case current through all driver FETs (i.e. any FETs with a source or drain of VDD or GND) to a “signal_rvdb” file so that power analysis can use those currents. This also includes writing currents through output drivers, which means that these stages are analyzed for currents, but no EM/SH checks are done on those stages and no resistor currents are reported for them.

The average and worst case currents are calculated in the signal run as follows. The worst case current is simply the worst case current through each driver FET seen during the signal run using the same activity factors (“AF”) and drive fights (“DF”) signal run. This current will be used in the worst case RVT power analysis, which is performed on the low level metal and via layers as specified in the global configuration file 414.

Calculating the average case current is a bit more complicated. The average case current is used to check EM/SH on the upper level metal and via layers as specified in the global configuration file 414, thus it is very important to get the current for the entire stage correct and not as important to get the current for each driver FET correct. Thus, for the average case power analysis, it is not advisable to use the worst case current. The global configuration file 414 may also specify different default activity factors for different node types to use with power analysis. For example, changing the default activity factor for static nodes to 0.2 instead of using the 0.5 used for worst case signal analysis, more accurately represents the power drawn.

During an RVT power analysis run, the RVT 400 collects the driver FET currents calculated during the RVT signal run, as described above, generates a power SPICE deck, simulates that deck, checks each resistor in the simulated grid against EM/SH rules, and generates output files, including violations files, and power grayboxes if requested to do so.

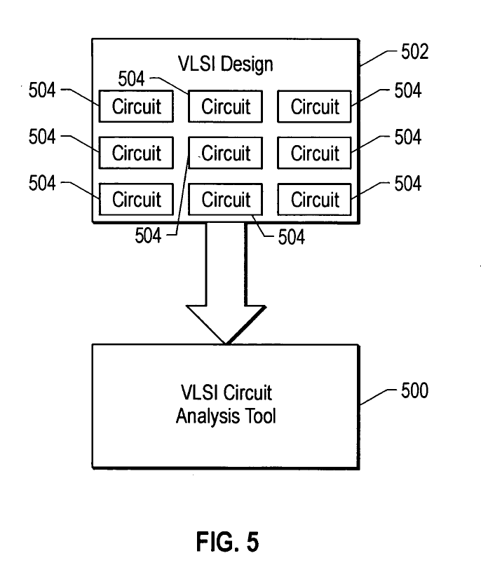

Referring now to FIG. 5, in one embodiment, a VLSI circuit analysis tool 500, which may comprise an RVT such as the RVT 400, implements a process to limit runtime by aborting analysis of a VLSI design 502 comprising a plurality of circuits, represented in FIG. 5 by circuits 504, if certain thresholds are met or exceeded. Various conditions may be used to determine whether analysis of one or more of the circuits 504 circuits of the design 502 will exceed or has already exceeded a given desirable runtime.

For example, one such condition may be that a circuit is deemed “too complex”. Circuit complexity may be measured by, for example, the number of FETs in the circuit or the number of possible logical paths through the circuit. Another condition might be the expiration of a predetermined time period following the initiation of the analysis of a circuit. Clearly, the first condition may be checked before the analysis begins, while the second condition will occur during analysis. In the event that a circuit is not analyzed, the tool 500 may provide a warning to the user of the tool of this situation, after which it will continue to analyze the remaining circuits in the design. The embodiment may also report any information that was generated during an aborted analysis of a circuit in spite of the fact that the analysis remains uncompleted. Thus, the embodiment enables the user to obtain valid results for all circuits of a design that can complete analysis in a reasonable amount of time, while providing as much data as possible about the circuits the analyses of which are aborted.

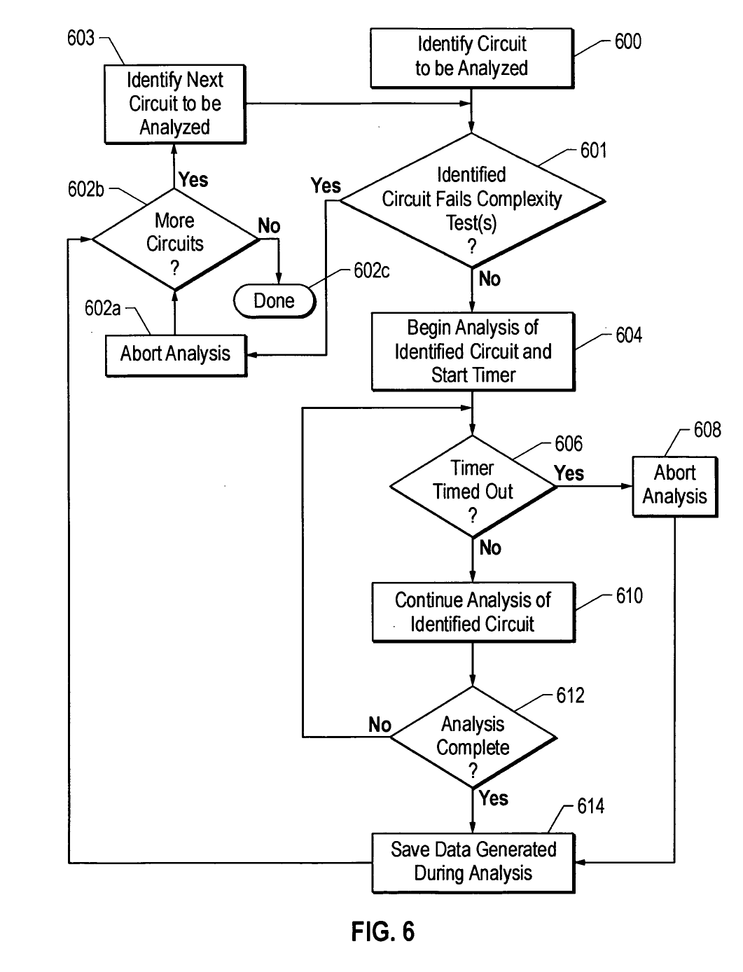

Referring now to FIGS. 5 and 6, operation of one embodiment of the tool 500 will be described. In step 600, a first one of the circuits 504 to be analyzed is identified. In step 601, a determination is made as to whether the identified circuit fails a complexity check. As previously noted, complexity checks may include whether of FETs of the identified circuit exceeds a preselected threshold value and whether the number of possible logical paths through the identified circuit exceeds a preselected threshold value. If it is determined that the identified circuit fails a complexity check, execution proceeds to step 602a, in which the analysis is aborted, and then to step 602b, in which a determination is made whether there are more circuits to be analyzed. If not, execution terminates in step 602c; otherwise, execution proceeds to step 603, in which a next one of the circuits 504 to be analyzed is identified. Execution then returns to step 601. In contrast, if it is determined in step 601 that the identified circuit does not fail a complexity check, execution proceeds to step 604.

In step 604, analysis of the identified circuit is initiated. At the same time, a timer set to timeout after a predetermined time period starts to run. In step 606, a determination is made whether the timer set in step 604 has timed out. If so, execution proceeds to step 608, in which analysis of the identified circuit is aborted; otherwise, execution proceeds to step 610, in which the identified circuit continues to be analyzed for a period of time. In step 612, a determination is made whether the analysis is complete. If not, execution returns to step 606; otherwise, execution proceeds to step 614. Similarly, if analysis of the identified circuit is aborted in step 608, execution proceeds to step 614.

In step 614, whatever data that has been generated as a result of any analysis of the identified circuit is saved and execution returns to step 602b.

It will be recognized that the process illustrated in FIG. 6 may be run in parallel on one or more machines such that more than one of the circuits 504 will be analyzed at a time.

The embodiment described herein provides facilities to limit the amount of time spent on analysis of a given circuit of an IC design, thereby reducing the total amount of time needed to analyze the entire design, while still providing results for the circuits that did not fail the conditional checks. Current VLSI circuit analysis tools are incapable of providing results for circuits that are analyzed after the analysis takes an inordinate amount of time since the analysis of the problem circuits cannot be aborted without aborting the entire run.

An implementation of the invention described herein thus provides system and method to limit runtime of VLSI circuit analysis tools for complex electronic circuits. The embodiments shown and described have been characterized as being illustrative only; it should therefore be readily understood that various changes and modifications could be made therein without departing from the scope of the present invention as set forth in the following claims.

1. A method of using a software tool to analyze a VLSI circuit, the method comprising:
prior to initiating analysis of the circuit, performing a complexity check on the circuit;
responsive to the circuit failing the complexity check, aborting analysis of the circuit; and
responsive to the circuit passing the complexity check:
initiating analysis of the circuit; and
continuing analysis of the circuit until expiration of a predetermined time period following the initiating.

2. The method of claim 1 further comprising, upon expiration of the predetermined time period, halting analysis of the circuit.

3. The method of claim 2 further comprising, responsive to the halting, saving data generated during the analysis.

4. The method of claim 1 wherein the performing a complexity check comprises determining whether a number of transistors comprising the circuit exceeds a preselected threshold value.

5. The method of claim 1 wherein the performing a complexity check comprises determining whether a number of possible logical paths through the circuit exceeds a preselected threshold value.

6. The method of claim 1 wherein the initiating analysis of the circuit further comprises setting a timer to time out upon expiration of a predetermined time period.

7. The method of claim 6 wherein the continuing analysis further comprises continuing analysis of the circuit until the timer times out.

8. The method of claim 1 wherein the initiating analysis of the circuit comprises initiating a process for verifying reliable operation of the circuit.

9. A computer-implemented tool for analyzing a VLSI circuit, comprising:
means for performing a complexity check on the circuit prior to initiating analysis thereof;
means responsive to the circuit failing the complexity check for aborting analysis of the circuit;
means responsive to the circuit passing the complexity check for initiating analysis of the circuit; and
means for continuing the analysis for a predetermined time period.

10. The computer-implemented tool of claim 9 further comprising means for halting analysis of the circuit upon expiration of the predetermined time period.

11. The computer-implemented tool of claim 10 further comprising means responsive to the halting for saving data generated during the analysis.

12. The computer-implemented tool of claim 9 wherein the means for performing a complexity check comprises means for determining whether a number of transistors of the circuit exceeds a preselected threshold value.

13. The computer-implemented tool of claim 9 wherein the means for performing a complexity check comprises means for determining whether a number of possible logical paths through the circuit exceeds a preselected threshold value.

14. The computer-implemented tool of claim 9 wherein the means for initiating analysis of the circuit further comprises means for setting a timer to time out upon expiration of a predetermined time period.

15. The computer-implemented tool of claim 14 wherein the means for continuing analysis of the circuit further comprises means for continuing analysis of the circuit until the timer times out.

16. The computer-implemented tool of claim 9 wherein the means for initiating analysis of the circuit comprises means for initiating a process to verify reliable operation of the circuit.

17. A computer-readable medium operable with a computer to analyze a VLSI circuit, the medium having stored thereon:
instructions executable by the computer for performing a complexity check on the circuit prior to initiating analysis thereof;
instructions executable by the computer responsive to the circuit failing the complexity check for aborting analysis of the circuit; and
instructions executable by the computer responsive to the circuit passing the complexity check for initiating analysis of the circuit and continuing analysis of the circuit until expiration of a predetermined time period following the initiating.

18. The computer-readable medium of claim 17 further having stored thereon instructions executable by the computer for halting analysis of the circuit upon expiration of the predetermined time period.

19. The computer-readable medium of claim 18 further having stored thereon instructions executable by the computer responsive to the halting for saving data generated during the analysis.

20. The computer-readable medium of claim 17 wherein the instructions for performing a complexity check comprise instructions for determining whether a number of transistors comprising the circuit exceeds a preselected threshold value.

21. The computer-readable medium of claim 17 wherein the instructions for performing a complexity check comprise instructions for determining whether a number of possible logical paths through the circuit exceeds a preselected threshold value.

22. The computer-readable medium of claim 17 wherein the instructions for initiating and continuing analysis of the circuit further comprise instructions for setting a timer to time out upon expiration of a predetermined time period.

23. The computer-readable medium of claim 22 wherein the instructions for initiating and continuing analysis of the circuit further comprise instructions for continuing analysis of the circuit until time out of timer.

24. The computer-readable medium of claim 17 wherein the instructions for initiating analysis of the circuit comprises instructions for initiating a process to locate one or more areas of the circuit that suffer at least one of electromigration and self-heating.
